(19) United States
(12) Patent Application Publication
(10) Pub. No.: US 2013/0076128 A1
(43) Pub. Date: Mar. 28, 2013

(54) Active Switching Frequency Modulation

(71) Applicant: Brett Michael Nee, Germantown Hills, IL (US)

(72) Inventor: Brett Michael Nee, Germantown Hills, IL (US)

(73) Assignee: CATERPILLAR, INC., Peoria, IL (US)

(21) Appl. No.: 13/246,958

(22) Filed: Sep. 28, 2011

(51) Int. Cl. B60L 11/18; B60K 6/20

(52) U.S. Cl. 307/10.1; 180/65.21

(57) ABSTRACT

A method of controlling a variable frequency power converter disposed on a vehicle, and a machine with such a variable frequency power converter is disclosed. The method may comprise providing a power controller, the variable frequency power converter and an electrical energy storage repository disposed on the vehicle. The method may further comprise receiving, by the power controller, a desired reference value, and adjusting a switching frequency of the variable frequency power converter from a first switching frequency to a second switching frequency based on the desired reference value.

### TECHNICAL FIELD

The present disclosure generally relates to high efficiency electrical power converters, and more particularly to reducing the current and power ripple resulting from such converters used in hybrid earth moving, construction, material handling, mining vehicles, and the like.

### BACKGROUND

Drive systems for machines typically include a motor connected to a wheel or other traction apparatus that operates to propel the machine. The drive system further includes a prime mover, for example, an engine, that drives a generator. The generator produces electrical power that is used to drive the motor. Mechanical power produced by the engine is converted to electrical power by the generator. This electrical power may then be processed and/or conditioned before being supplied to the motor and/or machine auxiliary devices. The motor transforms the electrical power back into mechanical power to drive the traction apparatus and to propel the vehicle.

Typical machines may also include brakes and other mechanisms for retarding or decelerating the machine. As the machine decelerates, the momentum of the machine may be transferred to the motor via the traction device. The motor may act as a generator to convert the kinetic energy of the machine to electrical energy that may be supplied to the drive system or an energy storage device on the machine.

Some machines, such as hybrid machines, are configured to store for later use the electrical energy provided by the engine or the electrical energy provided by the motor during a retarding mode of operation. Such energy may be conditioned by a power converter and then stored in electrical energy storage repositories such as batteries and the like. The stored energy may be used to power auxiliary devices and or drive the motor(s) on the machine to minimize engine use and to reduce fuel consumption.

U.S. Publication No. 2010/0321958 (“Brinlee et al.”) published Dec. 23, 2010 is an example of prior art related to control of switching frequency. Brinlee et al. discloses a power converter including a power switch, a controller for controlling the switching frequency and a magnetic device with a non-uniform gap. In Brinlee et al., system peak actual current is used to provide feedback on the value of inductance. Switching frequency is then adjusted based on the feedback in order to minimize the capacitors in the system. While this design may increase power conversion efficiency it requires the use of system peak actual current to provide the required feedback.

### SUMMARY OF THE DISCLOSURE

In accordance with one aspect of the disclosure, a method of controlling a variable frequency power converter disposed on a vehicle is disclosed. The method may comprise providing a power controller, the variable frequency power converter and an electrical energy storage repository disposed on the vehicle. The power controller may be coupled to the variable frequency power converter and the electrical energy storage repository. The method may further comprise receiving, by the power controller, a desired power reference value, and adjusting a switching frequency of the variable frequency power converter from a first switching frequency to a second switching frequency based on the desired power reference value.

In accordance with another aspect of the disclosure, method of controlling a variable frequency power converter disposed on a hybrid vehicle is disclosed. The method may comprise providing a power controller, the variable frequency power converter and an electrical energy storage repository disposed on the hybrid vehicle. The power controller may be coupled to the variable frequency power converter and the electrical energy storage repository. The method may further comprise obtaining, by the power controller, a desired current reference value, and adjusting a switching frequency of the variable frequency power converter from a first switching frequency to a second switching frequency based on the desired current reference value.

In accordance with a further aspect of the disclosure, an electric drive machine is disclosed. The machine may comprise an engine, a generator operatively coupled to the engine, a motor operatively coupled to one or more traction apparatus, an electrical energy storage repository, a closed loop variable frequency power converter coupled to the electrical energy storage repository, and a power controller coupled to the variable frequency power converter. The variable frequency power converter may include a switch moveable between a first and a second position. The power controller may be configured to scale the switching frequency of the variable frequency power converter as a function of a desired reference value.

### BRIEF DESCRIPTION OF THE DRAWINGS

FIG. 1 is a general schematic view of an exemplary embodiment of a drive system as applied to an electric drive machine in accordance with the teachings of this disclosure;

FIG. 2 is a flowchart illustrating exemplary steps of a method of controlling a power converter in accordance with the present disclosure;

FIG. 3 is a flowchart illustrating exemplary steps of a method of controlling a power converter in accordance with the present disclosure;

FIGS. 4A-C illustrate an exemplary relationship between switching frequency and power load and the effect on power and current ripple, in accordance with the present disclosure; and

FIGS. 5A-C illustrate an exemplary relationship between switching frequency and current and the effect on power and current ripple, in accordance with the present disclosure.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

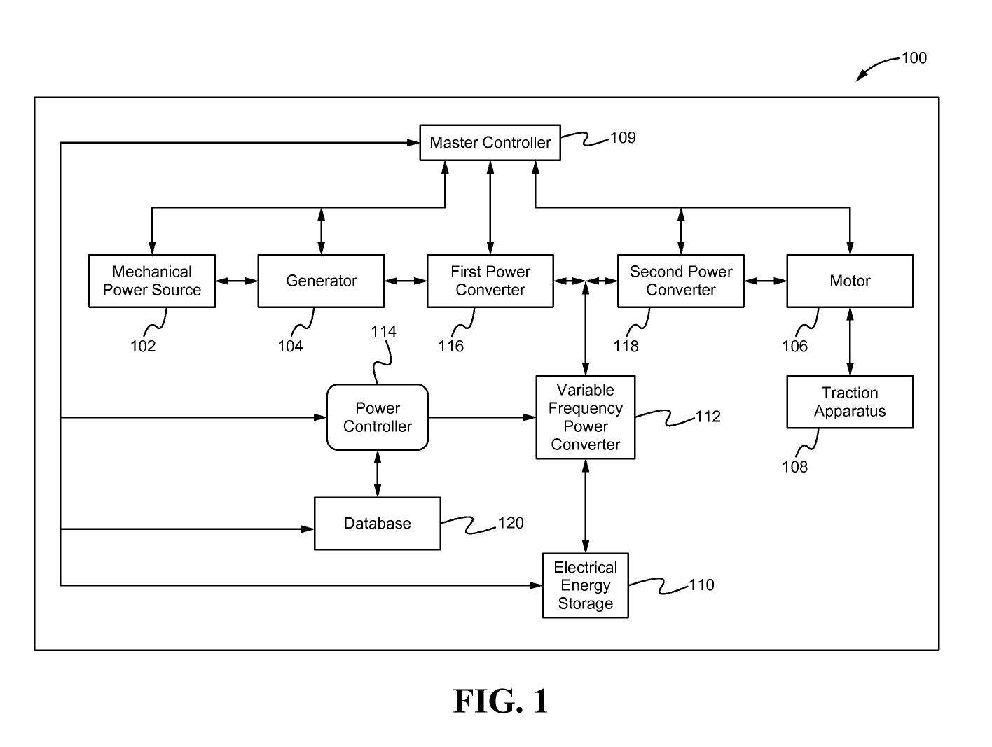

FIG. 1 schematically illustrates an exemplary electric drive machine 100. Such a machine may be, but is not limited to, an excavator, a wheel loader, on off-road truck, or a vehicle used in construction, mining, agriculture or other industrial applications. The electric drive machine 100 may include a mechanical power source 102, such as an engine, a generator 104 coupled to the engine 102, one or more traction motors 106, one or more final drive traction apparatus 108, a master controller 109, an electrical energy storage repository 110, a variable frequency power converter 112 and a power controller 114. The traction apparatus 108 propels and facilitates movement of the machine 100 and may be, but is not limited to, undercarriage such as that found on excavators and track-type machines, wheels, and the like. The machine 100 may further include additional power converters, such as the first power converter 116 and the second power convertor 118 illustrated in FIG. 1.

Overall control of the machine 100 may be managed by an embedded or integrated master controller 109 of the machine 100. The controller may take the form of one or more processors, microprocessors, microcontrollers, electronic control modules (ECMs), electronic control units (ECUs), or any other suitable means for electronically controlling functionality of the machine 100.

The master controller 109 may be configured to operate according to a predetermined algorithm or set of instructions for controlling the machine 100 based on various operating conditions of the machine 100. Such an algorithm or set of instructions may be read into an on-board memory of the master controller 109, or preprogrammed onto a storage medium or memory accessible by the controller 109, for example, in the form of a floppy disk, hard drive, optical medium, random access memory (RAM), read-only memory (ROM), or any other suitable computer readable storage medium commonly used in the art. The master controller 109 may be in electrical communication with the engine 102, the generator 106, the first and second converters 116, 118, the variable frequency power converter 112, the electrical energy storage repository 110, and the like. The master controller 109 may also be coupled to various other components, systems or sub systems (not pictured) of the machine 100. By way of such connection, the controller 109 may receive data pertaining to the current operating parameters of the machine 100 from sensors and the like. In response to such input, the master controller 109 may perform various determinations and transmit output signals corresponding to the results of such determinations or corresponding to actions that need to be performed.

In one embodiment, the electrical energy storage repository 110 may be a battery. In yet another embodiment, the electrical energy storage repository 110 may be one or more ultra capacitors. The variable frequency power converter 112 may condition power supplied by the electrical energy storage repository 110 to the machine 100. The variable frequency power converter 112 may also condition the power supplied from the engine 102 to the electrical energy storage repository 110 for storage. In addition, the variable frequency power converter 112 may condition regenerative power supplied from the machine 100, for example power generated from braking, to the electrical energy storage repository 110.

During a propel mode of operation, or when the machine 100 is being accelerated, power may be transferred from the engine 102 to the traction apparatus 108 to cause movement of the machine 100. Specifically, the engine 102 may produce an output torque to the generator 104, which may in turn convert the mechanical torque into electrical power. The electrical power may be generated in the form of alternating current (AC) power. The AC power may then be converted by the first converter 116 to direct current (DC) and, before being supplied to the motor 106, converted again from DC power to the appropriate amount of AC power by the second power converter 118. The resulting AC power may then be used to drive the one or more motors 106 and traction apparatus 108, as is known by those of skill in the art.

During a dynamic breaking mode of operation, or when the motion of the machine 100 is being retarded, power may be generated by the mechanical movement of the traction apparatus 108. In particular, the kinetic energy of the moving machine 100 may be converted into rotational power at the traction apparatus 108. Such rotational power of the traction apparatus 108 may further rotate the motor 106 so as to generate electrical power, for example, in the form of AC power. Such regenerative AC power produced may be converted to DC power by the second converter 118 and directed to the generator 104 to at least partially drive the engine 102 and/or may be directed to the variable frequency power converter 112 for conditioning before storage in the electrical energy storage repository 110.

In an embodiment, the variable frequency power converter 112 may comprise a closed loop switching regulator that regulates any, or combination of, voltage, current and/or power. The regulator may include a switching element moveable between a first and a second position, as is known in the art. The variable frequency power converter 112 may utilize a Pulse Width Modulation (PWM) process to control the switching frequency of the duty cycle in which the switching element in the closed loop switching regulator is opened and closed, as is known to one of skill in the art.

In an embodiment, the power controller 114 may be coupled to the variable frequency power converter 112. The power controller 114 may be separate from the master controller 109, coupled to the master controller 109 (as illustrated in FIG. 1) or part of the master controller 109. The power controller may take the form of one or more processors, microprocessors, microcontrollers, electronic control modules (ECMs), electronic control units (ECUs), or any other suitable means for electronically controlling functionality of the converter 112. The power controller 114 may be configured to operate according to a predetermined algorithm or set of instructions for controlling the variable frequency power converter 112. Such an algorithm or set of instructions may be read into an on-board memory of the power controller 114, or preprogrammed onto a storage medium or memory accessible by the power controller 114, for example, in the form of a floppy disk, hard drive, optical medium, random access memory (RAM), read-only memory (ROM), or any other suitable computer readable storage medium commonly used in the art.

The power controller 114 may, in one embodiment, be configured to adjust the switching frequency of the switch element of the variable frequency converter 112 from one frequency to another frequency based on a power reference. The power reference may be either the amount of discharge power desired by the machine 100 from the electrical energy storage repository 110 or the amount of power to charge the electrical energy storage repository 110 desired by the machine 100. Discharge from the electrical energy storage repository 110 may occur, for example, when the machine 100 requires the electrical energy storage repository 110 to provide propulsion to the machine 100, to provide power to auxiliary attachments to the machine 100, and the like.

As the value of the desired power reference (the desired power to or from the electrical energy storage repository 110) decreases, the power controller 114 may increase the switching frequency of the switch element of the variable frequency converter 112. For example, if the existing power reference (the amount of power currently provided to/from the electrical energy storage repository 110) is greater than the desired power reference, the power controller 114 may increase the switching frequency of the switch element of the variable frequency converter 112 from a first switching frequency (that corresponds to the existing power reference value) to a second switching frequency (that corresponds to the desired power reference value). Likewise, if the existing power reference is less than the desired power reference, the power controller 114 may decrease the switching frequency of the switch element of the variable frequency converter 112 from a first switching frequency (that corresponds to the existing power reference value) to a second switching frequency (that corresponds to the desired power reference value).

In one exemplary embodiment, the machine 100 may desire to charge the electrical energy storage repository 110. The master controller 109, or other controller, may retrieve from a database 120 or memory accessible by the controller a value representing the amount of power available from the electrical energy storage repository 110 when such is substantially fully charged (an initial amount). The master controller 109 may also receive data representing a measurement of the remaining power left in the electrical energy storage repository 110 at its present level of charge (a present amount). Such data may, but does not have to, originate from a sensor coupled to the electrical energy storage repository 110. The power reference, in this embodiment, may be the difference between the amount of power available from the electrical energy storage repository 110 when substantially fully charged (the initial amount) and the remaining power available from the electrical energy storage repository 110 at its present level of charge (the present amount). In other embodiments, for example, when the electrical energy storage repository 110 is supplying power to propel the machine 100, the power reference may be the power desired from the electrical energy storage repository 110 by the machine 100.

In some embodiments, the power controller 114 may adjust the switching frequency of the switch element in the variable frequency converter 112 only when the desired reference power falls within a predetermined range. In one embodiment, as the desired power reference decreases within a range that is less than about eighty percent of the variable frequency power converter's 112 power rating, the power controller 114 increases the switching frequency of the switch element of the variable frequency converter 112. In an alternative embodiment, this adjustment of the switching frequency of the switch element of the variable frequency converter 112 may only occur during low power conditions. One example of a low power condition is when the desired amount of power/energy to/from the electrical energy storage repository 110 is within a range that is less than about ten percent of the variable frequency power converter's 112 power rating.

The second switching frequency, may be determined by the power controller 114 using a function or algorithm executed by the power controller 114, or may be retrieved by the power controller 114 from a look-up table stored on the database 120. The power controller 114 may then adjust the existing switching frequency of the switching element in the variable frequency power converter 112, referred to herein as the first switching frequency, to the second frequency.

In another embodiment, the power controller 114 may be configured to adjust the switching frequency of the switch element of the variable frequency converter 112 from one frequency to another frequency based on a desired current reference. The desired current reference may be calculated by the power controller 114, the master controller 109 or another controller. Such desired current reference may represent the current that corresponds to, or is associated with, the desired power reference.

Using the example discussed above, the power controller 114 may, in one embodiment, be configured to adjust the switching frequency of the switch element of the variable frequency converter 112 from one frequency to another frequency based on the desired current reference. As the value of the desired current reference decreases, the power controller 114 may increase the switching frequency of the switch element of the variable frequency converter 112. For example, if the existing current reference (the existing current required to/from the electrical energy storage repository 110) is greater than the desired current reference, the power controller 114 may increase the switching frequency of the switch element of the variable frequency converter 112 from a first switching frequency (that corresponds to the existing current reference) to a second switching frequency (that corresponds to the desired current reference). Likewise, if the existing current reference is less than the desired power reference, the power controller 114 may decrease the switching frequency of the switch element of the variable frequency converter 112 from a first switching frequency (that corresponds to the existing current reference) to a second switching frequency (that corresponds to the desired current reference).

In some embodiments, the power controller 114 may adjust the switching frequency of the switch element in the variable frequency converter 112 only when the desired current reference falls within a predetermined range. In one embodiment, as the desired current reference decreases within a range that is less than about eighty percent of the variable frequency power converter's 112 current rating, the power controller 114 increases the switching frequency of the switch element of the variable frequency converter 112. In an alternative embodiment, this adjustment of the switching frequency of the switch element of the variable frequency converter 112 may only occur during low current conditions. One example of a low current condition is when the desired amount of current to/from the electrical energy storage repository 110 is within a range that is less than about ten percent of the variable frequency power converter's 112 current rating.

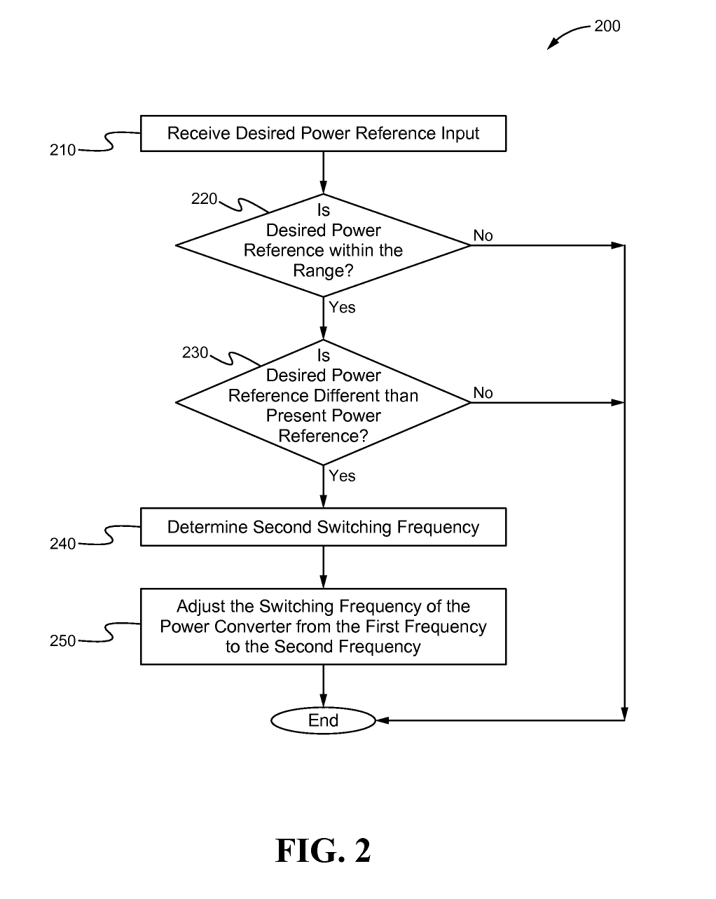

FIG. 2 is an exemplary method 200 for controlling a power converter coupled to a vehicle in accordance with an exemplary embodiment. The method may be practiced with more or less than the number of steps shown and is not limited to the order shown.

In step 210, the power controller 114 may receive the desired power reference. In one exemplary embodiment, the desired power reference value may be transmitted to the power controller 114 from the master controller 109 or another controller on the machine.

In step 220 of the method, the power controller 114 may determine whether the desired power reference is in a predetermined range (if applicable). If the desired power reference is in the predetermined range, the method progresses on to step 230. If the desired power reference is outside of the predetermined range, the process ends. In embodiments where there is no predetermined range, the process continues from step 210 to step 230.

In step 230, the power controller 114 compares the desired power reference to the existing power reference. If the desired power reference is different from the existing power reference, the process continues to step 240, otherwise the process ends.

In step 240, the power controller 114 determines the second switching frequency based on the desired power reference. The second switching frequency may be calculated from execution of a function or algorithm by the power controller 114 or may be retrieved by the power controller 114 from a look-up table stored on the database 120.

The power controller 114 in step 250 adjusts the switching frequency of the switch element of the variable frequency power converter 112 from the first switching frequency to the second switching frequency.

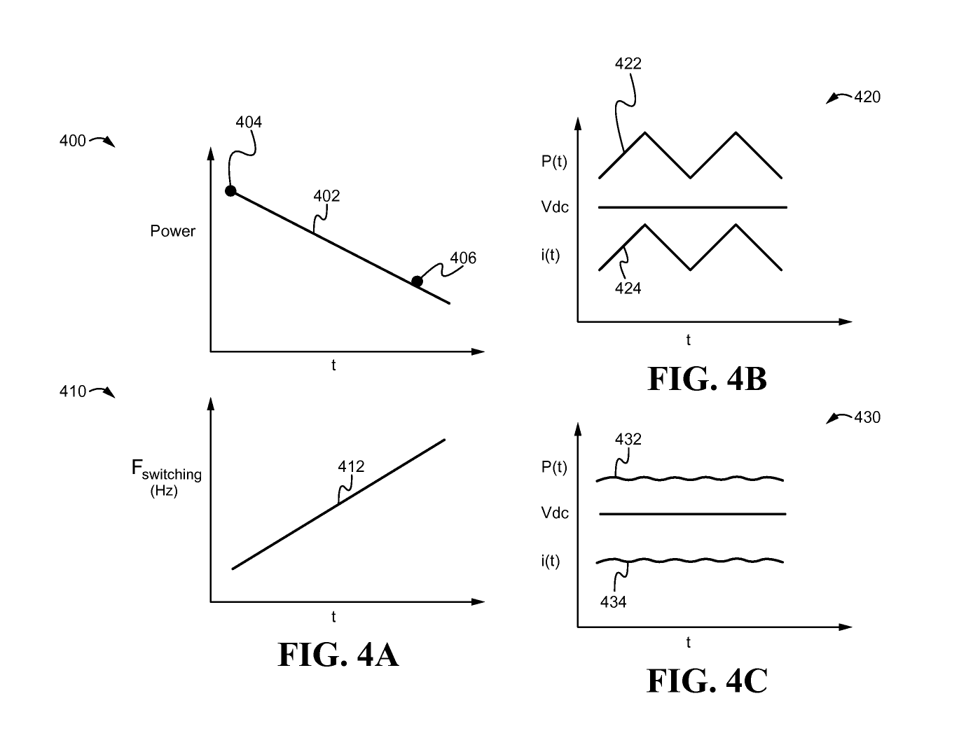

In hybrid machines, power (and current) ripple may occur when the desired power reference is within a certain range of the variable frequency power converter's power rating. Such power (or current) ripple may limit the amount of energy that can be stored or provided by the electrical energy storage repository 110. By adjusting the switching frequency of the switch element in the variable frequency converter 112, the amount of ripple may be reduced. More specifically, the power (or current) ripple may be reduced by increasing the switching frequency of the variable frequency power converter 112 as the desired power (or current) reference decreases. FIGS. 4A-C illustrate this concept in accordance with the teachings of this disclosure.

In FIG. 4A, two exemplary graphs are depicted illustrating the relationship between the power reference and the switching frequency. In the first graph 400, the power reference 402 is seen to be decreasing over time. In the second graph 410, the associated switching frequency 412 of the power converter 112 is illustrated as being increased, in accordance with the teachings of this disclosure, over as the power reference 402 decreases. Reading the two graphs 400, 410 together, the switching frequency 412 is increased as the power reference 402 decreases.

FIG. 4B illustrates a graph 420 that depicts an exemplary power ripple 422 and current ripple 424 at an exemplary power reference point 404 shown in graph 4A before any increase in the switching frequency in the power converter 112. FIG. 4C illustrates a graph 430 that depicts an exemplary power ripple 432 and an exemplary current ripple 434 at an exemplary desired power reference point 406 shown in graph 4A. The decrease in power ripple and current ripple seen in the comparison between graph 420 and graph 430 illustrates the effect on power ripple 422 and current ripple 424 when the switching frequency of the switching element in the power converter 112 is increased as the power reference 402 decreases.

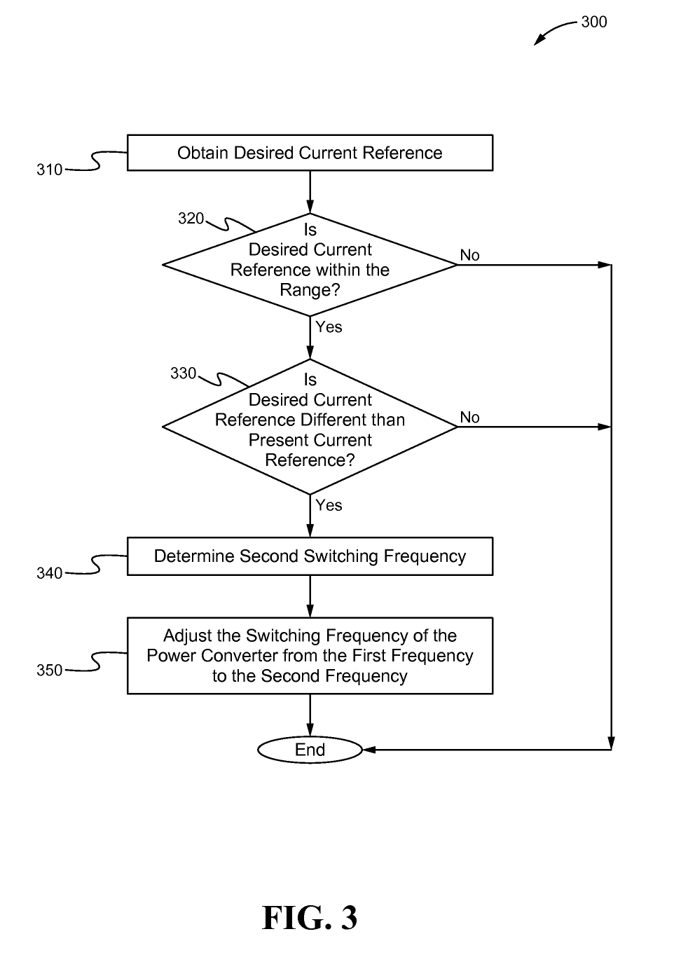

FIG. 3 is another exemplary method 300 for controlling a power converter coupled to a vehicle in accordance with an exemplary embodiment. The method may be practiced with more or less than the number of steps shown and is not limited to the order shown.

In step 310, the power controller 114 may obtain the desired current reference. In one exemplary embodiment, the desired current reference value may be transmitted to the power controller 114 from the master controller 109 or another controller on the machine. In another embodiment, the power controller 114 may calculate the desired current reference, as is known how to do in the art, based on a desired power reference received by the power controller 114.

In step 220 of the method, the power controller 114 may determine whether the desired current reference is in a predetermined range (if applicable). If the desired current reference is in the predetermined range, the method progresses on to step 230. If the desired current reference is outside of the predetermined range, the process ends. In embodiments where there is no predetermined range, the process continues from step 210 to step 230.

In step 230, the power controller 114 compares the desired current reference to the existing current reference. If the desired current reference is different from the existing current reference, the process continues to step 240, otherwise the process ends.

In step 240, the power controller 114 determines the second switching frequency based on the desired current reference. The second switching frequency may be calculated from execution of a function or algorithm by the power controller 114 or may be retrieved by the power controller 114 from a look-up table stored on the database 120.

The power controller 114 in step 250 adjusts the switching frequency of the switch element of the variable frequency power converter 112 from the first switching frequency to the second switching frequency.

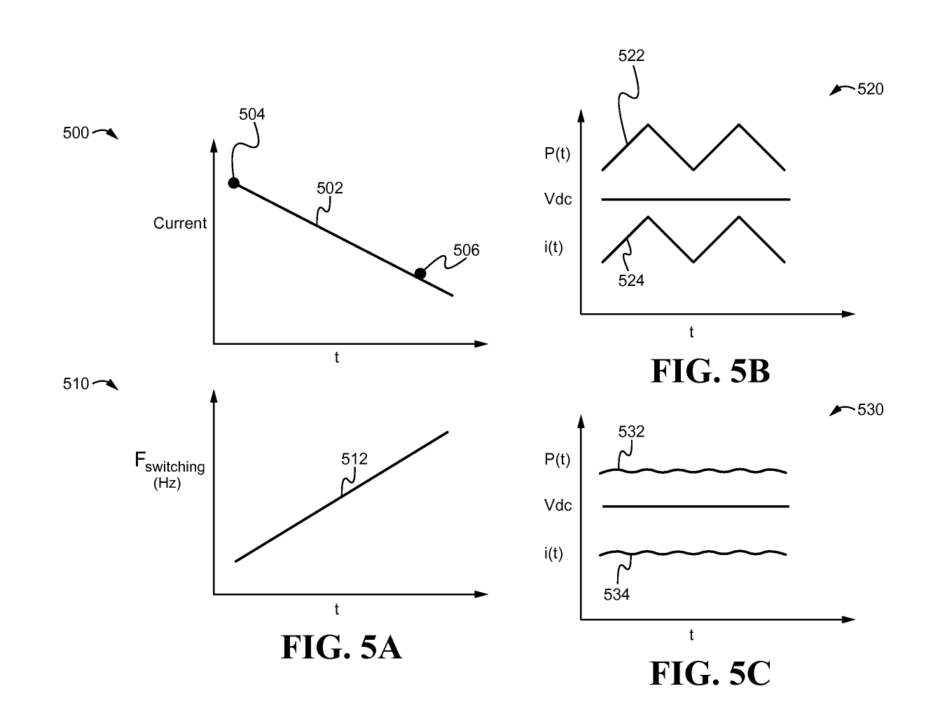

Similar to FIGS. 4A-C, FIGS. 5A-C illustrate that by adjusting the switching frequency of the switch element in the variable frequency converter 112, the amount of ripple may be reduced. More specifically, the power (or current) ripple may be reduced by increasing the switching frequency of the variable frequency power converter 112 as the desired current reference decreases.

In FIG. 5A, two exemplary graphs are depicted illustrating the relationship between the current reference and the switching frequency. In the first graph 500, the current reference 502 is seen to be decreasing over time. In the second graph 510, the associated switching frequency 512 of the power converter 112 is illustrated as being increased, in accordance with the teachings of this disclosure, as the current reference 502 decreases. Reading the two graphs 500, 510 together, the switching frequency 512 is increased as the current reference 502 decreases.

FIG. 5B illustrates a graph 520 that depicts an exemplary power ripple 522 and current ripple 524 at an exemplary current reference point 504 shown on graph 5A before any increase in the switching frequency in the power converter 112. FIG. 5C illustrates a graph 530 that depicts an exemplary power ripple 532 and an exemplary current ripple 534 at an exemplary desired current reference point 506 shown in graph 5A. The decrease in power ripple and current ripple seen in the comparison between graph 520 and graph 530 illustrates the effect on power ripple 522 and current ripple 524 when the switching frequency of the switching element in the power converter 112 is increased as the current reference 502 decreases.

### INDUSTRIAL APPLICABILITY

In hybrid machines that store power/energy in an electrical energy storage repository from the engine or from other regenerative sources or that obtain power/energy from an electrical energy storage repository, there is typically a power converter coupled to the electrical energy storage repository. Under certain conditions, power and current ripple may be exhibited during charging and discharging of the electrical energy storage repository. As is known in the art, this ripple limits the energy that can be stored or obtained from the electrical energy storage repository. The present disclosure may find applicability in reducing ripple by increasing the switching frequency as the desired power or current reference decreases.

In one embodiment the power controller receives a desired power reference. The power controller may then determine whether the desired power reference is in a predetermined range. The power controller may then determine whether the value of the desired power reference is different than the value of the existing power reference. If so, the power controller changes the switching frequency of the switch element in the variable frequency power converter based on the value of the desired power reference. As the power reference decreases, the switching frequency increases and vice versa. Such changing of the switching frequency reduces the power ripple and allows the electrical energy storage repository to charge/discharge faster.

In another embodiment, the power controller receives a desired current reference. The power controller may then determine whether the desired current reference is in a predetermined range. The power controller may then determine whether the value of the desired current reference is different than the value of the existing current reference. If so, the power controller changes the switching frequency of the switch element in the variable frequency power converter based on the value of the desired current reference. As the current reference decreases, the switching frequency increases and vice versa. Such changing of the switching frequency reduces the current ripple and allows the electrical energy storage repository to charge/discharge faster.

The features disclosed herein may be particularly beneficial to hybrid excavators, wheel loaders and other earth moving, construction, mining or material handling vehicles.

What is claimed is:

1. A method of controlling a variable frequency power converter disposed on a vehicle, the method comprising:
providing a power controller, the variable frequency power converter and an electrical energy storage repository disposed on the vehicle, the power controller coupled to the variable frequency power converter and the electrical energy storage repository;
receiving, by the power controller, a desired power reference value; and
adjusting a switching frequency of the variable frequency power converter from a first switching frequency to a second switching frequency based on the desired power reference value.

2. The method of claim 1, wherein the electrical energy storage repository is a battery.

3. The method of claim 1, wherein the electrical energy storage repository includes an ultra capacitor.

4. The method of claim 1, wherein the desired power reference value is within a range that is less than about eighty percent of the variable frequency power converter's power rating.

5. The method of claim 1, wherein the desired power reference value is within a range that is less than about ten percent of the variable frequency power converter's power rating.

6. The method of claim 1, further comprising selecting the second switching frequency from a look-up table stored in a database coupled to the power controller.

7. The method of claim 1, wherein the power converter is a closed loop switching regulator.

8. The method of claim 1, wherein the desired power reference value represents a difference between an initial amount of power available from the electrical energy storage repository when substantially charged and a present amount of power available from the electrical energy storage repository at a current level of charge.

9. The method of claim 1, wherein the second switching frequency is greater than the first switching frequency if the desired power reference value is less than an existing power reference value.

10. The method of claim 1, wherein the vehicle is an electric drive hybrid vehicle.

11. A method of controlling a variable frequency power converter disposed on a hybrid vehicle, the method comprising:
providing a power controller, the variable frequency power converter and an electrical energy storage repository disposed on the hybrid vehicle, the power controller coupled to the variable frequency power converter and the electrical energy storage repository;
obtaining, by the power controller, a desired current reference value; and
adjusting a switching frequency of the variable frequency power converter from a first switching frequency to a second switching frequency based on the desired current reference value.

12. The method of claim 11, wherein the electrical energy storage repository is a battery.

13. The method of claim 11, wherein the electrical energy storage repository includes an ultra capacitor.

14. The method of claim 11, wherein the current reference value is based on a desired power reference value.

15. The method of claim 11, wherein the desired current reference value is within a range that is less than about eighty percent of the variable frequency power converter's current rating.

16. The method of claim 11, further comprising selecting the second switching frequency from a look-up table stored in a database coupled to the power controller.

17. The method of claim 11, wherein the second switching frequency is greater than the first switching frequency if the desired current reference is less than an existing current reference.

18. An electric drive machine, the machine comprising:
an engine;
a generator operatively coupled to the engine;
a motor operatively coupled to one or more traction apparatus;
an electrical energy storage repository;
a closed loop variable frequency power converter coupled to the electrical energy storage repository, the variable frequency power converter including a switch moveable between a first and a second position; and
a power controller coupled to the variable frequency power converter, the power controller configured to scale the switching frequency of the variable frequency power converter as a function of a desired reference value.

19. The machine of claim 18, wherein the desired reference value is a desired power reference value.

20. The machine of claim 18, wherein the desired reference value is a desired current reference value.
